(19) United States
(12) Patent Application Publication
(10) Pub. No.: US 2009/0160744 A1
(43) Pub. Date: Jun. 25, 2009

(54) Light emitting device and display using the light emitting device, and method of driving the light emitting device

(76) Inventors: Tae-Sik Kim, Suwon-si (KR); Chul Ho Lee, Suwon-si (KR); Ji-Won Lee, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/318,141

(22) Filed: Dec. 22, 2008

(30) Foreign Application Priority Data
Dec. 24, 2007 (KR) 10-2007-0136506

(51) Int. Cl. G09G 3/34; H05B 37/02

(52) U.S. Cl. 345/84; 315/307

(57) ABSTRACT

In a light emitting device, a display device using the light emitting device, and a method of driving the light emitting device, the light emitting device includes: a plurality of cathode electrodes, an anode electrode, and a cathode driver to generate a light emitting data signal corresponding to a predetermined grayscale. In addition, an anode current flowing through the anode electrode is detected, the anode current and a first reference current corresponding to the predetermined grayscale are compared, and the anode current is compensated according to the comparison result.

### CLAIM OF PRIORITY

This application makes reference to, incorporates the same herein, and claims all benefits accruing under 35 U.S.C. §119 from an application for LIGHT EMITTING DEVICE AND DISPLAY USING THE LIGHT EMITTING DEVICE, THE DRIVING METHOD OF THE LIGHT EMITTING DEVICE earlier filed in the Korean Intellectual Property Office on the 24 Dec. 2007 and there duly assigned Serial No. 10-2007-0136506.

### BACKGROUND OF THE INVENTION

1. Field of the Invention

The present invention relates to a display device. More particularly, the present invention relates to a display device including a backlight unit driven in synchronism with a display image.

2. Description of the Related Art

Flat panel displays, such as Liquid Crystal Displays (LCDs), are display devices that display images by varying the amount of transmitted light for pixels using dielectric anisotropy of liquid crystals in which a twist angle varies in accordance with an supplied voltage. These LCDs are advantageous due to their light weight, small size, and low power consumption, as compared with a cathode ray tube which is a representative image display device.

LCDs generally includes a liquid crystal panel assembly and a backlight unit which is provided behind the liquid crystal panel assembly and supplies light to the liquid crystal panel assembly.

When the liquid crystal panel assembly is an active liquid crystal panel assembly, the liquid crystal panel assembly includes a pair of transparent substrates, a liquid crystal layer interposed between the transparent substrates, polarizing plates disposed on the outside of the transparent substrates, a common electrode provided on an inner surface of one of the transparent substrates, pixel electrodes and switches provided on an inner surface of the other transparent substrate, color filters that supply red, green, and blue colors to three sub-pixels forming one pixel, and the like.

The liquid crystal panel assembly is supplied with light emitted from the backlight unit and transmits or blocks the light using the liquid crystal layer so as to form a predetermined image.

A backlight unit may be classified into various types according to its light source, and a Cold Cathode Fluorescent Lamp (CCFL) is one type of backlight unit. Since the CCFL is a line light source, the CCFL may evenly disperse light generated by the CCFL toward a liquid crystal panel assembly through a diffusion sheet, a diffusion plate, or an optical member, such as a prism sheet.

However, since the light generated by the CCFL is transmitted through the optical member, a considerable optical loss occurs in the CCFL. Generally, in an LCD using a CCFL, it is known that the light that is transmitted through a liquid crystal panel assembly is about 3 to 5% of the light generated by the CCFL. Furthermore, the backlight unit of the CCFL type needs a considerable amount of power and consumes most of the power of the LCD. Since it is difficult to make a large CCFL due to its structure, it is not possible to apply a CCFL to a large-scale LCD that has a size of 30 inches or more.

In addition, a backlight unit using a Light Emitting Diode (hereinafter referred to as an LED) has been used. Generally, the LED is a point light source. A plurality of LEDs are generally provided. The LEDs are combined with optical members, such as a reflective sheet, a light guide plate, a diffusion sheet, a diffusion plate, or a prism sheet, to form the backlight unit.

The backlight unit using the LEDs is advantageous due to having a high response speed and excellent color reproducibility, but it is disadvantageous due to its high cost and large thickness.

As described above, each of the above-noted backlight units has problems according to the type of light source. Furthermore, since such a backlight unit is turned on with a predetermined brightness when the LCD is driven, it is difficult to improve the image quality required for the LCD. In addition, such a backlight unit has a problem in that its current value is continuously increased or decreased according to the life-span of an electron gun, or it contains harmful material.

### SUMMARY OF THE INVENTION

The present invention has been made in an effort to provide a light emitting device for compensating for a loss of current flowing through a front substrate of a backlight unit to prevent damage to the backlight unit and to stably operate it, a display device using the light emitting device, a method of driving the light emitting device, and a method of driving the display device.

An exemplary light emitting device according to an embodiment of the present invention includes a plurality of cathode electrodes, an anode electrode, and a cathode driver. The cathode driver generates a light emitting data signal corresponding to a predetermined grayscale. An anode current flowing through the anode electrode is detected, the anode current and a first reference current corresponding to the predetermined grayscale are compared, and the anode current is compensated according to a comparison result.

In an exemplary method of driving a light emitting device including a pixel for emitting light according to a scan signal supplied to a first electrode and a light emitting data signal supplied to a second electrode, and a third electrode through which a current generated in the pixel flows, a first reference current corresponding to the plurality of light emitting data signals is established, a second current flowing through the third electrode is measured, the second current and the first reference current are compared, and the light emitting data signal is varied according to a comparison result to compensate the second current.

An exemplary display device according to another embodiment of the present invention includes a panel assembly and a light emitting device. The panel assembly includes a plurality of gate lines for transmitting a plurality of gate signals, a plurality of data lines for transmitting a plurality of data signals, and a plurality of pixels defined by the plurality of gate lines and the plurality of data lines. The light emitting device includes a plurality of scan lines for transmitting a plurality of scan signals, a plurality of column lines for transmitting a plurality of light emitting data signals, a plurality of light emitting pixels defined by the plurality of scan lines and the plurality of column lines, a cathode electrode to which a cathode voltage is supplied, a gate electrode to which a gate voltage is supplied, and an anode electrode to which an anode voltage is supplied. The light emitting device measures an anode current flowing through the anode electrode for every predetermined time period, establishes a first reference current corresponding to the amount of luminance, compares the first reference current and the anode current, and increases or decreases a first voltage supplied to the cathode electrode according to a comparison result.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a cross-sectional view of a light emitting device according to a first exemplary embodiment of the present invention.

FIG. 2 is a cross-sectional view of the light emitting device according to a second exemplary embodiment of the present invention.

FIG. 3 is a partial exploded perspective view representing the inside of the valid area of the light emitting device for self-displaying an image.

FIG. 4 is a partial exploded perspective view representing the inside of the light emitting device for a light source.

FIG. 5 is an exploded perspective view of the display device according to a third exemplary embodiment of the present invention in which the light emitting device of FIG. 4 is used as the light source.

FIG. 6 is a diagram of the display device according to a fourth exemplary embodiment of the present invention.

FIG. 7 is a flowchart of a method of driving a plasma display according to the fourth exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is coupled to another element, the element may be directly coupled to the other element or coupled to the other element through a third element. In addition, unless explicitly described to the contrary, the word “comprise” and variations such as “comprises” or “comprising” will be understood to imply the inclusion of stated elements but not the exclusion of any other elements.

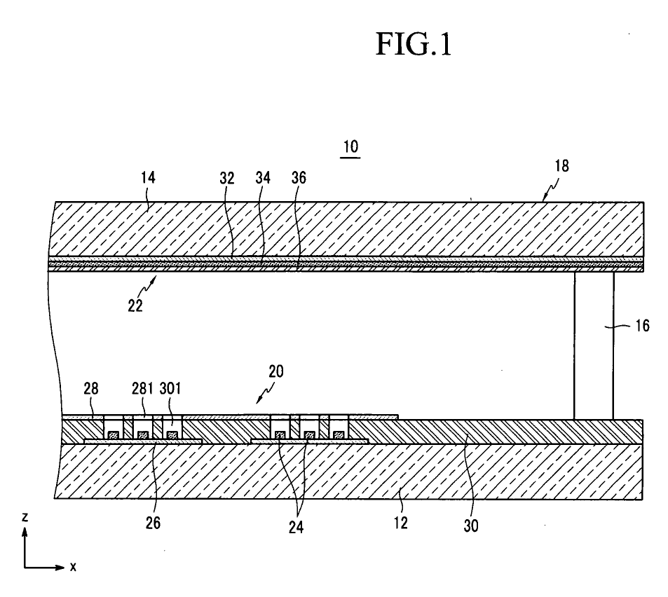

FIG. 1 is a cross-sectional view of a light emitting device according to a first exemplary embodiment of the present invention.

Referring to FIG. 1, a light emitting device 10 according to the first exemplary embodiment of the present invention includes a vacuum container 18 including first and second substrates 12 and 14 that are arranged opposite to each other, and a sealing member 16 disposed between the first substrate 12 and the second substrate 14 to seal the substrates 12 and 14. An inner space of the vacuum container 18 is maintained with a vacuum of 10-6 Torr.

An area inside the sealing member 16 and the first and second substrates 12 and 14 is classified as a valid area for contributing an actual visible light emission and an invalid area surrounding the valid area. An electron emitting unit 20 for emitting electrons is provided by the valid area of the first substrate 12, and a light emitting unit 22 for emitting visible light is provided toward the valid area of the second substrate 14.

The second substrate 14 on which the light emitting unit 22 is positioned is a front substrate of the light emitting device 10, and the first substrate 12 on which the electron emitting unit 20 is positioned is a rear substrate of the light emitting device 10.

The electron emitting unit 20 includes an electron emission region 24, and driving electrodes for controlling electron emission of the electron emission region 24. The driving electrodes include a cathode electrode 26 and a gate electrode 28 formed to cross the cathode electrode 26. In this case, an insulation layer 30 is provided between the cathode electrode 26 and the anode electrode 28.

Openings 281 and 301 are formed on the gate electrode 28 and the insulation layer 30 at each crossing region of the cathode electrode 26 and the gate electrode 28 to partially expose a surface of the cathode electrode 26, and the electron emission region 24 is positioned on the cathode electrode 26.

The electron emission region 24 is formed of a material that emits electrons when an electric field is supplied thereto under a vacuum atmosphere, such as a carbon-based material or a nanometer-sized material. For example, the electron emission region 24 may be formed of carbon nanotubes, graphite, graphite nanofibers, diamond, diamond-like carbon, fullerene (C60), silicon nanowires, or a combination thereof.

Alternatively, the electron emission region 24 may be formed of a molybdenum-based (Mo-based) material or a silicon-based (Si-based) material. In this case, the electron emission regions 30 may be formed in a sharp tip structure.

In the above configuration, one crossing region of the cathode electrode 26 and the gate electrode 28 may correspond to one pixel area of the light emitting device 10, or more than two crossing regions may correspond to one pixel area of the light emitting device 10.

The light emitting unit 22 includes an anode electrode 32, a phosphor layer 34 positioned on one surface of the anode electrode 32, and a metal reflective layer 36 covering the phosphor layer 34. The anode electrode 32 receives an anode voltage from a power source unit (not shown) outside the vacuum container 18 to maintain the phosphor layer 34 at a high potential state. In addition, the anode electrode 32 is formed as a transparent conductive layer, such as Indium Tin Oxide (ITO), so as to transmit visible light emitted from the phosphor layer 34.

The metal reflective layer 36 may be formed of aluminum with a thickness of several thousand angstroms (Å), and it includes minute holes for transmitting an electron beam. In addition, the metal reflective layer 36 reflects visible light, emitted by the phosphor layer 34 toward the first substrate 12, to the second substrate 14 to increase the luminance of a light emitting surface. Furthermore, the anode electrode 32 may be eliminated, and the metal reflective layer 36 may receive the anode voltage to perform as the anode electrode.

In the valid area, spacers (not shown) for supporting compression applied to the vacuum container 18 and for maintaining a space between the first and second substrates 12 and 14 are provided between the substrates 12 and 14.

The above light emitting device 10 supplies a predetermined driving voltage to the cathode electrode 26 and the gate electrode 28, and supplies a positive Direct Current (DC) voltage that is more than several thousand volts to the anode electrode 32. That is, a scan driving voltage is supplied to either the cathode electrode 26 or the gate electrode 28, and a data driving voltage is supplied to the other electrode.

Electrons are emitted since an electric field is formed around the electron emission region 24 in the pixels in which a voltage difference between the cathode electrode 26 and the gate electrode 28 is greater than a threshold value, and light is emitted since the emitted electrons are conducted by the anode voltage to collide against the corresponding phosphor layer 34. The light emitting intensity of the phosphor layer 34 for each pixel corresponds to an amount of electron beam emission of the corresponding pixel.

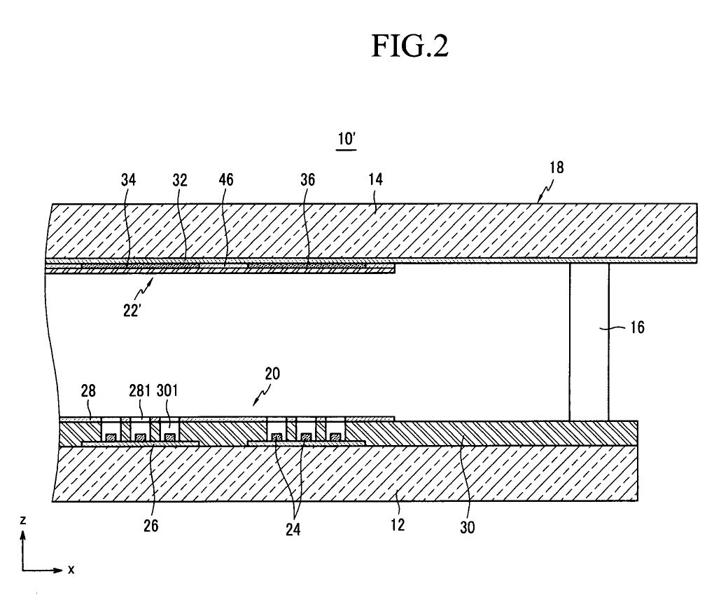

FIG. 2 is a cross-sectional view of a light emitting device according to a second exemplary embodiment of the present invention.

As shown in FIG. 2, a light emitting device 10′ according to the second exemplary embodiment of the present invention is the same as that of the first exemplary embodiment of the present invention except that a light emitting unit 22 includes a dark colored layer 46. The same reference numerals are used for elements that are the same as those of the first exemplary embodiment of the present invention.

In the second exemplary embodiment of the present invention, the phosphor layers 34 are positioned to have predetermined intervals therebetween, and the dark colored layer 46 is provided between the phosphor layers 34. The dark colored layer 46 may be formed of chromium. In the second exemplary embodiment of the present invention, the anode electrode 32 may be eliminated, and the metal reflective layer 36 may receive the anode voltage to perform as the anode electrode.

The above light emitting devices 10 and 10′ may be used as light sources for supplying white light to a passive display panel, or they may include a red phosphor layer, a green phosphor layer, and a blue phosphor layer to self-display an image.

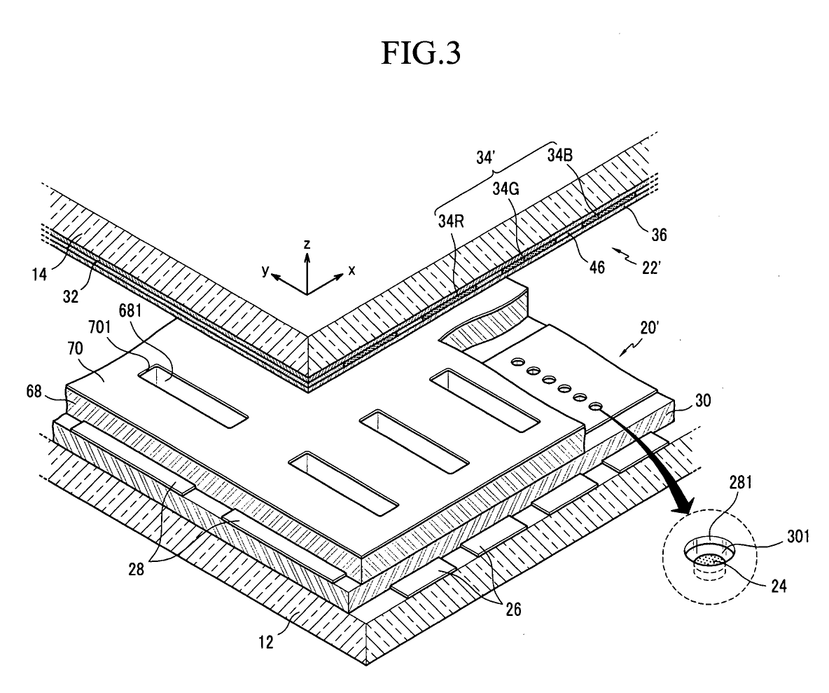

FIG. 3 is a partial exploded perspective view of the inside of the valid area of the light emitting device for self-displaying an image.

As shown in FIG. 3, an electron emitting unit 20′ of the light emitting device for self-displaying the image includes the cathode electrode 26, the gate electrode 28, and the electron emission region 24 electrically connected to the cathode electrode 26. In addition, when the insulation layer 30 positioned between the cathode electrode 26 and the gate electrode 28 is referred to as a first insulation layer, a second insulation layer 68 and a focusing electrode 70 formed on the gate electrode 28.

The second insulation layer 68 and the focusing electrode 70 respectively include openings 681 and 701 for transmitting the electron beam, and the focusing electrode 70 receives a voltage of 0V or a negative DC voltage of several to several tens of volts to concentrate the electrons transmitted through the focusing electrode opening 701.

The light emitting unit 22′ includes the anode electrode 32, a red phosphor layer 34R, a green phosphor layer 34G, and a blue phosphor layer 34B that are provided on the anode electrode 32 while having intervals therebetween, the dark colored layer 46 provided between phosphor layers 34′, and the metal reflective layer 36 covering the phosphor layer 34′ and the dark colored layer 46.

The crossing region of the cathode electrode 26 and the gate electrode 28 may correspond to one subpixel, and the red phosphor layer 34R, the green phosphor layer 34G, and the blue phosphor layer 34B respectively correspond to one subpixel. Three subpixels respectively corresponding to the red phosphor layer 34R, the green phosphor layer 34G, and the blue phosphor layer 34B form one pixel.

The electron emission of the electron emission region 24 for each subpixel is determined by the driving voltage supplied to the cathode electrode 26 and the gate electrode 28, and the electrons collide against the phosphor layer 34′ of the corresponding subpixel to excite the phosphor layer 34′. Since the light emitting device controls the luminance for each pixel and the light emitting color through the above operations, it realizes a color screen.

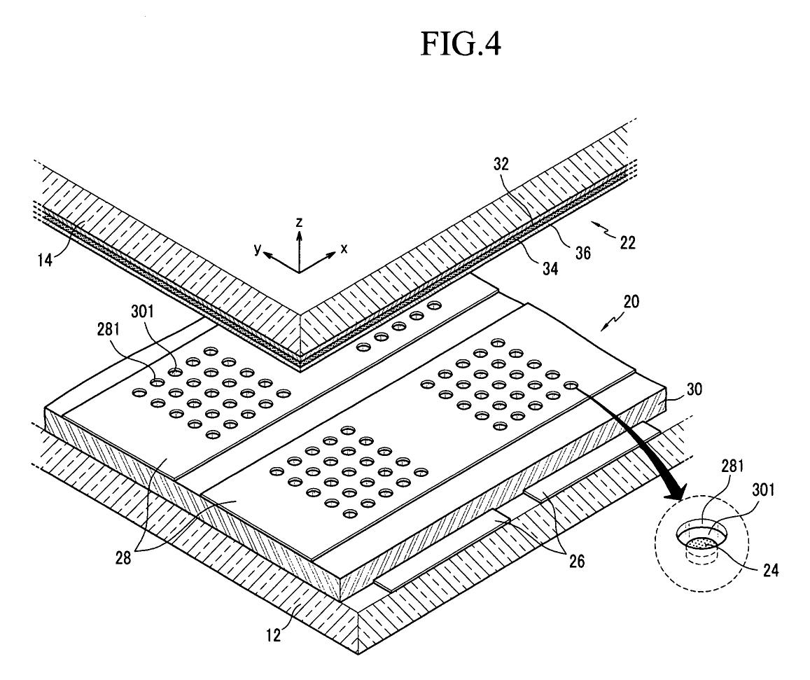

FIG. 4 is a partial exploded perspective view representing the inside of the light emitting device for a light source.

As shown in FIG. 4, the electron emitting unit 20 of the light emitting device for the light source includes the cathode electrode 26, the gate electrode 28, and the electron emission region 24 electrically connected to the cathode electrode 26. In addition, the light emitting unit 22 includes the anode electrode 32, the phosphor layer 34 for emitting the white light, and the metal reflective layer 36 covering the phosphor layer 34.

The phosphor layer 34 may include phosphors of mixed red, green, and blue phosphors to emit the white light, and it may be positioned on the entire valid area of the second substrate 14.

In the light emitting device for the light source, the first substrate 12 and the second substrate 14 are positioned with a relatively large gap of 5 to 20 mm therebetween. Since the gap between the first substrate 12 and the second substrate 14 is large, an arc-discharge in the vacuum container is reduced, and a high voltage of more than 10 kV (actually, 10 to 15 kV) is supplied to the anode electrode 32. The above light emitting device may realize a maximum luminance of 10,000 cd/m² on a center of the valid area.

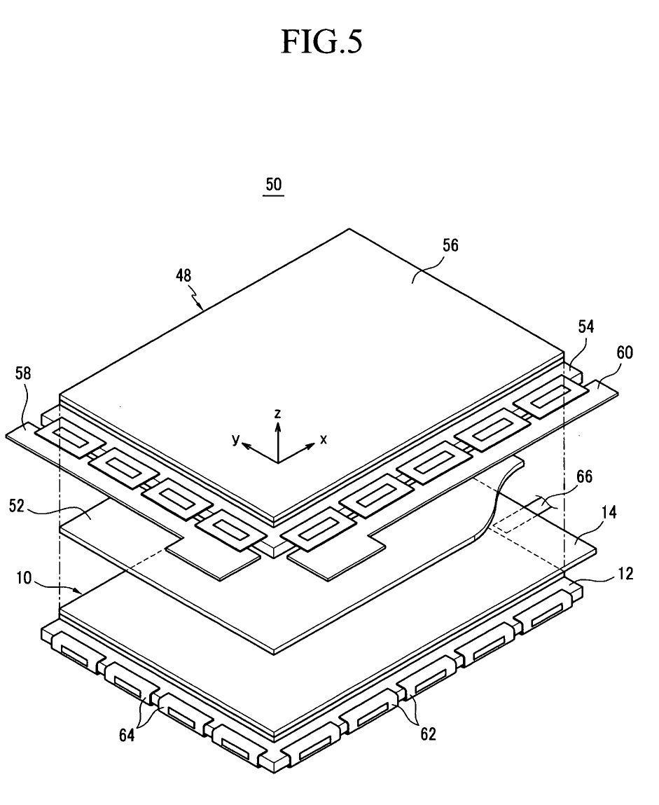

FIG. 5 is an exploded perspective view of a display device according to a third exemplary embodiment of the present invention in which the light emitting device of FIG. 4 is used as the light source.

As shown in FIG. 5, the display device 50 according to the third exemplary embodiment of the present invention includes the light emitting device 10, and a display panel 48 provided on a front part of the light emitting device 10. A diffusion plate 52 for evenly diffusing the light output from the light emitting device 10 is provided between the light emitting device 10 and the display panel 48, and the diffusion plate 52 and the light emitting device 10 are arranged to have a predetermined gap therebetween.

The display panel 48 may be an LCD panel or another type of passive display panel. In the following description, the display panel 48 is assumed to be an LCD panel.

The display panel 48 includes a lower substrate 54 on which a plurality of Thin Film transistors (TFT) are formed, an upper substrate 56 on which a color filter is formed, and a liquid crystal layer (not shown) provided between the substrates 54 and 56. Polarizing plates (not shown) for polarizing the light transmitted through the display panel 48 are arranged on an upper surface of the upper substrate 56 and a lower surface of the lower substrate 54.

Transparent pixel electrodes, driven by the TFTs, are provided for each subpixel on the lower substrate 54, and a color filter layer and a transparent common electrode are provided on the upper substrate 56. The color filter layer includes a red filter layer, a green filter layer, and a blue filter layer for each subpixel.

When the TFT of a predetermined subpixel is turned on, an electric field is formed between the pixel electrode and the common electrode, an arrangement angle of liquid crystal molecules varies according to the electric field, and light transmittance varies according to the varied arrangement angle. The display panel 48 adjusts the luminance and the light emitting color for each pixel through the operations described above.

In FIG. 5, a gate printed circuit board assembly (PBA) 58 for transmitting a gate driving signal to a gate electrode of each TFT is provided, and a data PBA 60 for transmitting a data driving signal to a source electrode of each TFT is also provided.

The number of pixels of the light emitting device 10 is less than that of the display panel 48, and accordingly, one pixel of the light emitting device 10 corresponds to two or more pixels of the display panel 48. The respective pixels of the light emitting device 10 correspond to the highest grayscale among the plurality pixels of the display panel 48 to emit the light, and the light emitting device 10 expresses grayscales of 2 to 8 bits for each pixel.

For convenience, the pixel of the display panel 48 is referred to as a first pixel, the pixel of the light emitting device 10 is referred to as a second pixel, and the first pixels corresponding to one second pixel are referred to as a first pixel group.

In the method of driving the light emitting device 10, (a) a signal controller (not shown) for controlling the display panel 48 detects the highest grayscale among the first pixels of the first pixel group, (b) a grayscale for emitting light in the second pixel is calculated according to the detected grayscale and is converted to digital data, (c) a driving signal of the light emitting device is generated by using the digital data, and (d) the generated driving signal is supplied to a driving electrode of the light emitting device 10.

A scan PBA and a data PBA for driving the light emitting device 10 is provided on a rear surface of the light emitting device 10. In FIG. 5, a connection member 62 is provided for connecting the cathode electrode to the data PBA, and a connection member 64 is provided for connecting the gate electrode to the scan PBA.

As described above, when an image is displayed in the first pixel group corresponding to the second pixel of the light emitting device 10, the second pixel is synchronized with the first pixel group to emit the light of a predetermined grayscale. That is, the light emitting device 10 provides high luminance light to a bright part of a screen realized by the display panel 48, and provides low luminance light to a dark part thereof. Accordingly, the display device 50 according to the exemplary embodiment of the present invention increases the dynamic contrast of a screen, and realizes a high quality image.

In addition, in the light emitting device 10, a part of the second substrate 14 is extended toward the outside of the sealing member to have an anode lead line disposed thereon. The anode lead line is connected to a power source unit (not shown) through the connection member 66 to receive an anode voltage from the power source unit.

A display device using the light emitting device for the light source of FIG. 4 and FIG. 5 according to a fourth exemplary embodiment of the present invention and a driving method thereof are described below.

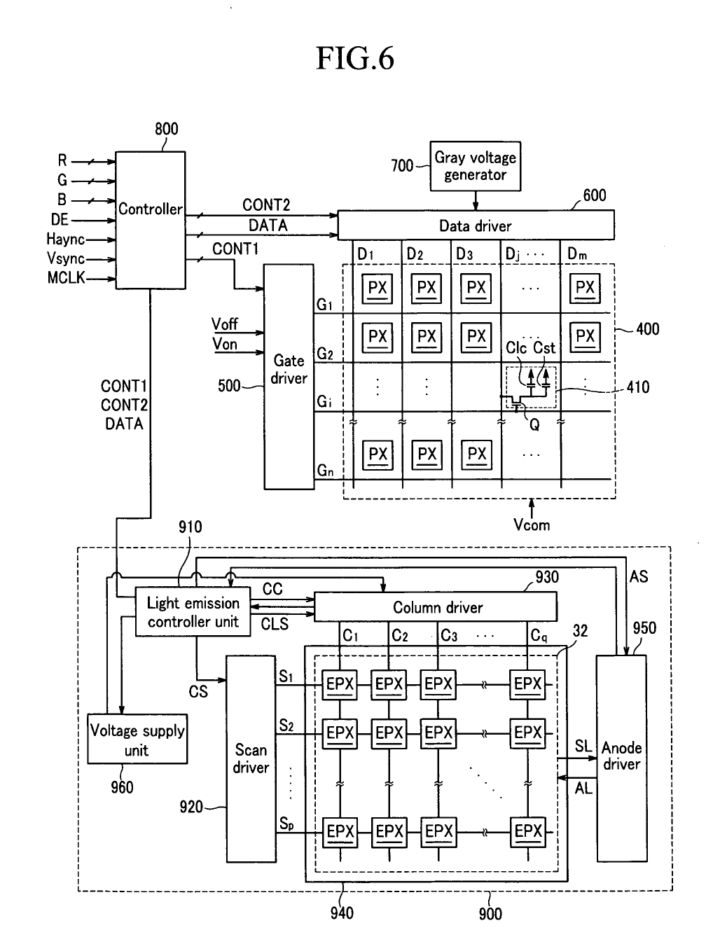

FIG. 6 is a block diagram of a display device according to the fourth exemplary embodiment of the present invention. The display device according to the exemplary embodiment of the present invention includes a liquid crystal panel assembly using a liquid crystal element as a light receiving element. However, the present invention is not limited thereto.

As shown in FIG. 6, the display device according to the fourth exemplary embodiment of the present invention includes a liquid crystal panel assembly 400, a gate driver 500 and a data driver 600 connected to the liquid crystal panel assembly 400, a gray voltage generator 700 connected to the data driver 600, a light emitting device 900, and a signal controller 800 for controlling them.

In terms of an equivalent circuit, the liquid crystal panel assembly 400 includes a plurality of signal lines G1 to Gn and D1 to Dm and a plurality of pixels PX connected to the plurality of signal lines G1 to Gn and D1 to Dm and arranged substantially in a matrix form. The signal lines G1 to Gn and D1 to Dm include a plurality of gate lines G1 to Gn for transmitting gate signals and a plurality of data lines D1 to Dm for transmitting data signals.

Each pixel PX, e.g., a pixel 410 connected with the ith (i=1, 2, . . . , n) gate line Gi and the jth (j=1, 2, . . . , m) data line Dj, includes a switching element Q connected to the signal lines Gi and Dj, and a liquid crystal capacitor Clc and a storage capacitor Cst connected thereto. The storage capacitor Cst can be omitted as necessary.

The switching element Q is a three-terminal element such as a Thin Film Transistor (TFT) provided on the lower panel 100, and includes a control terminal connected to the gate line Gi, an input terminal connected to the data line Dj, and an output terminal connected to the liquid crystal capacitor Clc and the storage capacitor Cst.

The gray voltage generator 700 generates two sets of gray voltages (or a set of reference gray voltages) related to transmittance of the pixels PX. One of the two sets of gray voltages has a positive value and the other has a negative value.

The gate driver 500 is connected to the gate lines G1 to Gn of the liquid crystal panel assembly 400 to supply a gate signal formed by a combination of an on-voltage Von for conducting the switch of the liquid crystal pixel and an off-voltage Voff for interrupting the switch to the gate lines G1 to Gn.

The data driver 600 is connected to the data lines D1 to Dm of the liquid crystal panel assembly 400, and selects a gray voltage from the gray voltage generator 700 to supply the gray voltage to the data lines D1 to Dm. However, when the gray voltage generator 700 provides a predetermined number of reference gray voltages rather than providing voltages for each gray value, the data driver 600 divides the reference gray voltages to generate gray voltages for all the grays and selects a data signal from among them.

The signal controller 800 controls the gate driver 500, the data driver 600, and a light emission controlling unit 910. The signal controller 800 receives input video signals R, G, and B from an external graphics controller (not shown) and an input control signal for controlling the display of the input video signals.

The input image signals R, G, and B include luminance information of each pixel PX, and the luminance has a predetermined number of grays (e.g., 1024 (=210), 256 (=28), or 64 (=26)). The input control signal includes a vertical synchronization signal Vsync, a horizontal synchronizing signal Hsync, a main clock signal MCLK, and a data enable signal DE.

The signal controller 800 appropriately processes the input video signals R, G, and B according to an operational condition of the liquid crystal panel assembly 400 based on the input control signal, generates a gate control signal CONT1 and a data control signal CONT2, transmits the gate control signal CONT1 to the gate driver 500, and transmits the data control signal CONT2 and the processed video signals DATA to the data driver 600. In addition, the signal controller 800 transmits the gate control signal CONT1, the data control signal CONT2, and the processed video signal DATA to the light emission controlling unit 910.

The light emitting device for the light source (hereinafter referred to as a “light emitting device”) 900 according to the fourth exemplary embodiment of the present invention includes the light emission controlling unit 910, a scan driver 920, a column driver 930, a light emitting unit 940, an anode driver 950, an anode electrode 32, and a voltage supply unit 960.

As shown in FIG. 6, the column driver 930 is connected to a plurality of column lines C1 to Cq, and each column line functions as the cathode electrode 26 of FIG. 4 of a light emitting pixel EPX and is connected to the electron emission region 24 of FIG. 4. In addition, the voltage supply unit 960 is connected to the light emission controlling unit 910 to supply a predetermined voltage VA to the column driver 930 according to a control operation of the light emission controlling unit 910. The scan driver 920 is connected to a plurality of scan lines S1 to Sp, and each scan line functions as the gate electrode 28 of FIG. 4 of the light emitting pixel EPX.

The light emitting unit 940 includes the plurality of scan lines S1 to Sp for transmitting the scan signal, the plurality of column lines C1 to Cq for transmitting the light emitting data signal, and the plurality of light emitting pixels EPX. Each light emitting pixel EPX is positioned at an area defined by the scan lines S1 to Sp and the column lines C1 to Cq crossing the scan lines. The scan lines S1 to Sp are connected to the scan driver 920, and the column lines C1 to Cq are connected to the column driver 930. In addition, the scan driver 920 and the column driver 930 are connected to the light emission controlling unit 910 to be driven according to the control signal of the light emission controlling unit 910.

The light emission controlling unit 910 detects the highest grayscale among the plurality of pixels PX corresponding to the light emitting pixel EXP, and determines a grayscale of the plurality of light emitting pixels EXP corresponding to the detected grayscale. In addition, the light emission controlling unit 910 converts the determined grayscale into digital data to transmit the digital data to the column driver 930, and in this case, the digital data are included in a light emitting signal CLS. Furthermore, the light emission controlling unit 910 uses the gate control signal CONT1 to generate a scan driving control signal CS, and transmits the scan driving control signal CS to the scan driver 920. The light emission controlling unit 910 uses the data control signal CONT2 to generate a light emission control signal CC, and transmits the generated light emission control signal CC to the column driver 930. When the display device is driven, the light emission controlling unit 910 generates an anode control signal AS so that the anode driver 950 transmits a predetermined voltage to the anode electrode 32.

The scan driver 920 is connected to the plurality of scan lines S1 to Sp, and transmits the plurality of scan signals so that each light emitting pixel EPX is synchronized with a plurality of liquid crystal pixels EX corresponding to the light emitting pixels EPX to emit light according to the scan driving control signal CS.

The column driver 930 is connected to the plurality of column lines C1 to Cq, and controls each light emitting pixel EPX to emit the light in correspondence with the grayscale of the plurality of liquid crystal pixels EX corresponding to the light emitting pixels EPX according to the light emission control signal CC and the light emitting signal CLS. The column driver 930 generates a plurality of light emitting data signals according to the light emitting signal CLS, and transmits them to the plurality of column lines C1 to Cq according to the light emission control signal CC. That is, the light emitting pixel EPX is synchronized to an image displayed on the plurality of liquid crystal pixels EX corresponding to one light emitting pixel EPX to emit light with a predetermined grayscale. The column driver 930 according to the exemplary embodiment of the present invention receives the voltage VA from the voltage supply unit 960, and increases or decreases the cathode voltage Vs supplied to the plurality of column lines C1 to Cq to compensate an anode current.

When receiving the anode control signal AS from the light emission controlling unit 910, the anode driver 950 supplies the anode voltage to the anode electrode 32 of FIG. 4 according to the anode control signal AS. In more detail, the anode control signal AS is a pulse signal that is synchronized to have a high level when the display device is started to be driven, and the anode driver 950 is synchronized at a rising edge timing of the anode control signal AS to supply the anode voltage to the anode electrode 32.

In addition, the anode driver 950 uses a sensing line SL to sense the anode current flowing through the anode electrode 32 of FIG. 4 while electrons are emitted according to the predetermined voltage supplied to the cathode electrode 26 of FIG. 4 and the gate electrode 28 of FIG. 4. In the exemplary embodiment of the present invention, the anode current is sensed every predetermined period, and the predetermined period is established by a user's preference.

The anode electrode 32 is included in a front substrate of the light emitting device 900, and is connected to an anode line AL and the sensing line SL. The anode driver 950 supplies the anode voltage to the anode electrode 32 through the anode line AL, the anode electrode 32 is an accelerating electrode for drawing the emitted electron beam, and the anode voltage is a high voltage. In addition, the anode current is generated in the anode electrode 32 by the electrons pulled by the anode voltage when the electrons are emitted according to a difference Vgs between the voltages supplied to the cathode electrode 26 of FIG. 4 and the gate electrode 28 of FIG. 4.

The size of the anode current according to the exemplary embodiment of the present invention is determined by the electrons emitted according to the predetermined voltages supplied to the cathode electrode 26 of FIG. 4 and the gate electrode 28 of FIG. 4. That is, when the voltage difference Vgs between the cathode electrode 26 of FIG. 4 and the gate electrode 28 of FIG. 4 increases, the amount of electrons emitted from the cathode electrode 26 of FIG. 4 increases, and the anode current increases. In addition, when the voltage difference Vgs between the cathode electrode 26 of FIG. 4 and the gate electrode 28 of FIG. 4 decreases, the amount of electrons emitted from the cathode electrode 26 of FIG. 4 decreases, and the anode current decreases. The generated anode current is measured for every predetermined period, and the measured anode current Iaf is transmitted to the light emission controlling unit 910.

The light emission controlling unit 910 determines whether the measured anode current Iaf is within a normal range. In more detail, when light emitting luminance of a backlight unit pixel EPX is different from luminance corresponding to the light emitting data signal supplied to the cathode electrode 26 of FIG. 4 due to deterioration of the electron emission region 24 of FIG. 4 and harmful materials, the measured anode current Iaf deviates from the normal range. The light emission controlling unit 910 establishes a reference anode current Ia corresponding to the plurality of light emitting data signals, compares it with the measured anode current Iaf, and controls the scan signal transmitted to the scan electrode to compensate the anode current according to a comparison result. In this case, the reference anode current Ia is a current flowing to the anode electrode 32 when the light is emitted with a normal luminance according to the light emitting data signal without being affected by the deterioration and the harmful material.

In addition, since the light emission controlling unit 910 controls the voltage supplied to the cathode electrode 26 of FIG. 4, the light emission controlling unit 910 controls the difference Vgs between the voltages supplied to the cathode electrode 26 of FIG. 4 and the gate electrodes 28 of FIG. 4. Accordingly, the light emitting device 900 according to the fourth exemplary embodiment of the present invention adjusts the amount of electrons emitted according to the voltage difference Vgs, and compensates the anode current.

In more detail, the light emission controlling unit 910 receives the measured anode current Iaf that is sensed while the electrons are emitted according to the voltage difference Vgs supplied to the cathode electrode 26 FIG. 4 and the gate electrode 28 FIG. 4, and compares the measured anode current Iaf and the reference anode current Ia. The reference anode current Ia is determined by the light emitting data signal. The reference anode current Ia increases as the luminance increases according to the light emitting data signal, and the reference anode current Ia decreases as the luminance decreases. In more detail, the light emission controlling unit 910 establishes the reference anode current Ia according to an average grayscale corresponding to an entire average luminance of the light emitting unit 940.

The light emission controlling unit 910 calculates the average grayscale according to the light emitting signal CLS, and the reference anode current Ia is previously stored in a data base (not shown) according to the average grayscale. The light emission controlling unit 910 calculates the average grayscale, detects the reference anode current Ia corresponding to the calculated average grayscale, and compares the detected anode current Ia and the measured anode current Iaf.

The light emitting device 900 controls the voltage supply unit 960 according to the comparison result to vary the voltage VA transmitted to the column driver 930. When the measured anode current Iaf is greater than the reference anode current Ia, the light emission controlling unit 910 controls the voltage supply unit 960 to increase the cathode voltage. Thereby, the voltage difference Vgs decreases, and the measured anode current decreases. In addition, when the measured anode current Iaf is less than the reference anode current Ia, the light emission controlling unit 910 controls the voltage supply unit 960 to decrease the cathode voltage. Thereby, the voltage difference Vgs increases, and the measured anode current increases.

In more detail, the light emission controlling unit 910 calculates a variation range ΔV of the voltage VA as given by Equation 1. When the calculated variation range ΔV is transmitted to the voltage supply unit 960, the voltage supply unit 960 generates the voltage VA according to the variation range ΔV and transmits the voltage to the anode driver 950. Thereby, the anode driver 950 varies the cathode voltage Vs according to the voltage VA, and transmits the varied cathode voltage Vs to the cathode electrode 26 of FIG. 4. In this case, the cathode voltage is given by Equation 2.

ΔV=K*(Iaf−Ia) Equation 1

Vs_{—}n+1=Vs_{—}n+K′ΔV Equation 2

When the variation range ΔV of the voltage VA is negative, the cathode voltage Vs decreases, and the voltage difference Vgs between the cathode electrode 26 of FIG. 4 and the gate electrode 28 of FIG. 4 increases, and therefore the anode current is increased and compensated. When the variation range ΔV of the voltage VA is positive, the cathode voltage Vs increases, the voltage difference Vgs between the cathode electrode 26 of FIG. 4 and the gate electrode 28 of FIG. 4 decreases, and the anode current is decreased and compensated.

In this case, K′ΔV denotes a compensation value of the cathode voltage Vs. K′ denotes a proportion constant number between the voltage VA and the cathode voltage Vs.

The light emission controlling unit 910 compares the cathode voltage Vs transmitted from the column driver 930 and a threshold voltage Vs_th to protect the light emitting device 900. The threshold voltage Vs_th is an output threshold value of the cathode voltage Vs established to protect a circuit. In more detail, the light emission controlling unit 910 compares the cathode voltage Vs and the threshold voltage Vs_th, and maintains the cathode voltage Vs to be at the threshold voltage when the cathode voltage Vs is greater than the threshold voltage Vs_th.

As described above, the light emission controlling unit 910 measures the anode current, controls the voltage supply unit 930 to increase or decrease the cathode voltage Vs according to the measured result, and compensates the luminance variation caused by the deterioration. In addition, the threshold voltage Vs_th is used to adjust a maximum value of the cathode voltage Vs to obtain the stability of the light emitting device 900.

The voltage supply unit 960 supplies the voltage VA corresponding to the control signal corresponding to the variation range ΔV received from the light emission controlling unit 910 to the column driver 930 to adjust the cathode voltage Vs supplied to the cathode electrode 26 of FIG. 4.

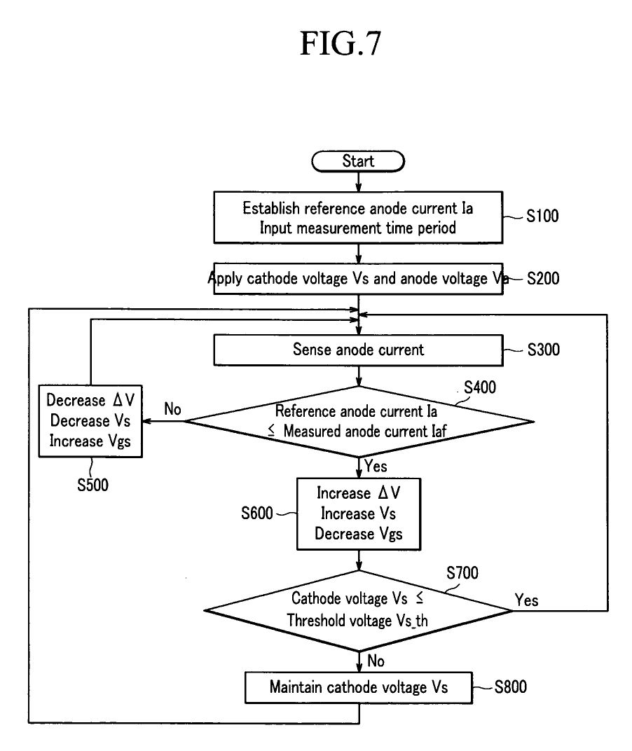

FIG. 7 is a flowchart of a method of driving the plasma display according to the fourth exemplary embodiment of the present invention.

Firstly, the backlight unit controlling unit 910 establishes the reference anode current Ia and a measurement time period in step S100. The cathode voltage according to the light emitting data signal is supplied to the cathode electrode 26 of FIG. 4 after supplying the anode voltage to the anode electrode 32 of FIG. 4 so as to cause a predetermined current to flow in step S200. The light emission controlling unit 910 senses the anode current in step S300 while the electrons are emitted according to the difference Vgs between the voltages supplied to the cathode electrode 26 of FIG. 4 and the gate electrode 28 of FIG. 4. The reference anode current Ia established in step S100 and the measured anode current Iat sensed in step S300 are compared in step S400.

When the measured anode current Iaf is less than the reference anode current Ia in step S400, the voltage VA transmitted to the column driver 930 is reduced to compensate the anode current, and the step S300 is performed in step S500. Since the cathode voltage Vs is decreases when the voltage VA is decreased, the voltage difference Vgs between the cathode electrode 26 of FIG. 4 and the gate electrode 28 of FIG. 4 increases, and the anode current is increased and compensated.

When the measured anode current Iaf is greater than the reference anode current Ia in step S400, the voltage VA transmitted to the column driver 930 is increased to compensate the anode current in step S600. In more detail, since the cathode voltage Vs is increased when the voltage VA is increased, the voltage difference Vgs between the cathode electrode 26 of FIG. 4 and the gate electrode 28 of FIG. 4, and the anode current, is decreased and compensated.

The light emission controlling unit 910 compares the increased cathode voltage Vs and the threshold voltage Vs_th in step S700. When the increased cathode voltage Vs is less than the threshold voltage Vs_th in step S700, the step S300 is performed.

When the increased cathode voltage Vs is greater than the threshold voltage Vs_th in step S700, the cathode voltage Vs is maintained to be at the threshold voltage Vs_th in step S800. In this case, the cathode voltage Vs is continuously output before the cathode voltage Vs is continuously increased to reach the threshold voltage Vs_th, so that a circuit is protected.

As described above, since the voltage VA supplied to the cathode electrode 26 of FIG. 4 is adjusted when the anode current is increased or decreased, the inappropriate current variation of the light emitting device 900 is prevented, and the anode current is compensated to stably drive the light emitting device 900.

Hereinbefore, the display device using the liquid crystal panel assembly according to the exemplary embodiments of the present invention has been described. However, the present invention is not limited thereto. The present invention may be applied to a display device that receives light from a backlight unit to display an image as well as a self-emitting display device.

In addition, the self-light emitting device described with reference to FIG. 3 compensates the cathode voltage by the method described above.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

In the light emitting device according to the exemplary embodiment of the present invention, the display device using the light emitting device, and in the method of driving the light emitting device, when an inappropriate current is detected, the voltage supplied to the cathode electrode is adjusted, the damage caused by the inappropriate current variation is prevented, and the light emitting device is stably driven.

What is claimed is:

1. A light emitting device comprising:
a plurality of cathode electrodes;
an anode electrode;
a cathode driver to generate a light emitting data signal corresponding to a predetermined grayscale;
a current detector to detect an anode current flowing through the anode electrode;
a comparator to compare the anode current and a first reference current to the corresponding predetermined grayscale; and
a compensator to compensate the anode current according to a comparison result.

2. The light emitting device of claim 1, wherein a cathode voltage supplied to the cathode electrode is increased by the compensator to decrease the anode current according to the comparison result.

3. The light emitting device of claim 2, wherein the comparator compares the cathode voltage supplied to the cathode electrode and a predetermined threshold voltage, and the compensator maintains the cathode voltage at the threshold voltage when the cathode voltage is determined to be greater than the threshold voltage, and the predetermined threshold voltage is set to protect the inside of the light emitting device.

4. The light emitting device of claim 1, wherein the cathode voltage supplied to the cathode electrode is decreased by the compensator to increase the anode current according to the comparison result.

5. A method of driving a light emitting device including a pixel for emitting light according to a scan signal supplied to a first electrode and a light emitting data signal supplied to a second electrode, and a third electrode through which a current generated in the pixel flows, the method comprising:
establishing a first reference current corresponding to the plurality of light emitting data signals;
measuring a second current flowing through the third electrode;
comparing the second current and the first reference current; and
varying the light emitting data signal according to a comparison result to compensate the second current.

6. The driving method of claim 5, further comprising:
increasing a first voltage of the light emitting data signal in response to the first reference current being less than or equal to the second current;
comparing the first voltage to a predetermined threshold voltage; and
maintaining the first voltage in response to the first voltage being greater than the threshold voltage.

7. The driving method of claim 6, further comprising decreasing the first voltage of the light emitting data signal in response to the first reference current being greater than the second current.

8. A display device comprising:
a panel assembly including a plurality of gate lines to transmit a plurality of gate signals, a plurality of data lines to transmit a plurality of data signals, and a plurality of pixels defined by the plurality of gate lines and the plurality of data lines; and
a light emitting device including a plurality of scan lines to transmit a plurality of scan signals, a plurality of column lines to transmit a plurality of light emitting data signals, a plurality of light emitting pixels defined by the plurality of scan lines and the plurality of column lines, a cathode electrode supplied with a cathode voltage, a gate electrode supplied with a gate voltage, and an anode electrode supplied with an anode voltage;
wherein an anode current flowing through the anode electrode is measured for every predetermined time period;
a first reference current corresponding to the amount of luminance is established;
the first reference current and the anode current are compared; and
a first voltage supplied to the cathode electrode is increased or decreased according to the comparison result.

9. The display device of claim 8, wherein the light emitting device increases the first voltage in response to the anode current being greater than the first reference current.

10. The display device of claim 9, wherein the light emitting device maintains the increased first voltage in response to the increased first voltage being greater than a threshold voltage.

11. The display device of claim 10, wherein the threshold voltage has a maximum output threshold value of the first voltage to protect a circuit.

12. The display device of claim 8, wherein the light emitting device decreases the first voltage in response to the anode current being less than the first reference current.

13. The display device of claim 8, wherein the first reference current is determined according to an average grayscale corresponding to an entire average luminance.
